(19) United States
(12) Patent Application Publication
(10) Pub. No.: US 2008/0066224 A1
(43) Pub. Date: Mar. 20, 2008

(54) PUSH BUTTON INCREMENTAL AIR CONTROL VALVE

(76) Inventor: Russ Wooten, Oxford, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/532,218

(22) Filed: Sep. 15, 2006

(51) Int. Cl. A61H 33/06

(52) U.S. Cl. 4/541.5

(57) ABSTRACT

The present invention provides an air control valve for hydrotherapy equipment. The air control valve incrementally controls the supply of air to a venturi jet of the hydrotherapy equipment, thus regulating the flow of air that is mixed with water passing through the venturi jet. Various embodiments of the invention comprise a cammed assembly that translates axial movement of at least one axial member into rotational movement of at least one rotational member, thereby regulating the volume of air flow through a conduit communicating with the air control valve and the venturi jet. Further, various embodiments comprise a push button air control valve that actuates incremental regulation of the air flow volume to the venturi jet.

### BACKGROUND OF THE INVENTION

1. Technical Field

The present invention is generally directed to air (gas) and water (liquid) induction devices and methods for hydrotherapy equipment and more particularly to an air (gas) control valve for regulating the flow of air (gas) and, alternatively a water (liquid) control valve for regulating the flow of water (liquid), to a venturi jet in a spa, hot tub, whirlpool bath, swimming pools and the like.

2. Related Art

Conventional spas, hot tubs, whirlpool baths, swimming pools and the like, hereinafter referred to and defined as hydrotherapy equipment, comprise therapeutic jet heads that inject water together with air, if desired, using venturi nozzles or jets, against the bodies of occupants usually partially immersed therein.

The propelling of a combination of air and water through a venturi jet creates the hydromassage or hydrotherapy effect provided by hydrotherapy equipment. Such equipment generally comprises at least one jet through which water is pumped into the spa, bathtub, hot tub, swimming pool, etc. Each jet further comprises a venturi region that creates a partial vacuum when water flows through it. Known hydrotherapy equipment uses an air valve to control the supply of air to the venturi region and the associated venturi jet, so that when the air valve is open, air is drawn through the valve and into the jet, where it mixes with the water flowing into and through the hydrotherapy equipment.

Conventional spas, baths and the like, however, include rotatable control elements or knobs for the incremental adjusting or regulating the flow of air or water through associated venturi jet(s). See, for example, U.S. Pat. No. 4,592,100 to Robertson, et al., the disclosure of which is hereby incorporated in its entirety. Such known designs may become difficult to adjust or rotate over time due to effects of water intrusion and subsequent corrosion. In addition, those with hand strength or pain issues, for example, persons with arthritis, may find it difficult to rotate conventional control elements.

Accordingly, there is a need for a device that allows for the regulation of the volume of air flow through hydrotherapy equipment spa jets to an artificial body of water, such as a spa, swimming pool, tub, hydrotherapy equipment or the like with a minimum of manufacturing and installation costs. It is to these needs and others that the present invention is directed.

### BRIEF SUMMARY OF THE INVENTION

The present invention provides an air (or other gas) control valve for hydrotherapy equipment. The air control valve controls the supply of air to a venturi jet of the hydrotherapy equipment, thus regulating the flow of air that is mixed with water passing through the venturi jet. Various embodiments of the invention comprise a cammed assembly that translates axial movement of at least one axial member into rotational movement of at least one rotational member, thereby regulating the volume of air flow through a conduit communicating with the air control valve and the venturi jet. Further, various embodiments comprise a push button air control valve that actuates regulation of the air flow volume to the venturi jet.

Embodiments of the invention provide a device for regulating the volume of air flow through hydrotherapy equipment venturi jets using a cammed assembly. Other embodiments of the invention provide a device that controls the flow of air into at least one venturi jet by actuating a push button controller. Still other embodiments of the invention provide an incremental air flow controller for hydrotherapy equipment that is less difficult to actuate than known controllers.

Alternatively, the same or a substantially similar structure can be used to provide a water (or other liquid) control valve for hydrotherapy equipment. In a manner similar to as disclosed above, the control valve can be used to control the supply of water to the venturi jet of the hydrotherapy equipment, thus regulating the flow of water that is mixed with air passing through the venturi jet.

These features, and other features and advantages of the present invention will become more apparent to those of ordinary skill in the relevant art when the following detailed description of the preferred embodiments is read in conjunction with the appended drawings in which like reference numerals represent like components throughout the several views. The figures and the detailed description which follow more particularly exemplify these and other embodiments of the invention.

### BRIEF DESCRIPTION OF THE DRAWINGS

The invention may be more completely understood in consideration of the following detailed description of various embodiments of the invention in connection with the accompanying drawings, which are as follows.

FIG. 1 illustrates one embodiment of the air control valve installed in exemplary hydrotherapy equipment.

FIG. 2 is an exploded view of one embodiment of the air control valve.

FIG. 3 is a partial view of the interior of one embodiment of the air control valve.

FIGS. 4A, 4B and 4C illustrate one embodiment of the relationship of the camming surfaces of the air control valve.

FIGS. 5A and 5B illustrate a bottom view of one embodiment of the air control valve with the rotating member in exemplary rotational positions.

FIG. 6 illustrates an exploded view of an alternate embodiment of the air control valve.

### DETAILED DESCRIPTION OF THE PREFERRED EMBODIMENTS

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

The following disclosure describes a control valve for use in controlling the air input to a venturi jet for illustrative purposes. It is to be understood that the invention also includes the use of a control valve for use in controlling the water input to the venturi jet. Similarly, the invention also includes the use of a control valve for controlling the input of other gases and liquids to a jet for subsequent introduction to a piece of hydrotherapy equipment. Further, the term hydrotherapy equipment is meant to include the array of devices for holding acting upon water and other fluids including, but not limited to, spas, tubs, swimming pools, ponds, fountains, showers, whirlpools, and the like.

Additionally, the following disclosure describes a preferred embodiment of the control valve having at least three positions: closed (off), partially open (partially on), and full open (full on). It is to be understood that the invention also includes two positions, closed (off) and open (on) as well as four or more positions, closed (off), open (on), and two or more intermediate positions for various degrees of partially open (partially on).

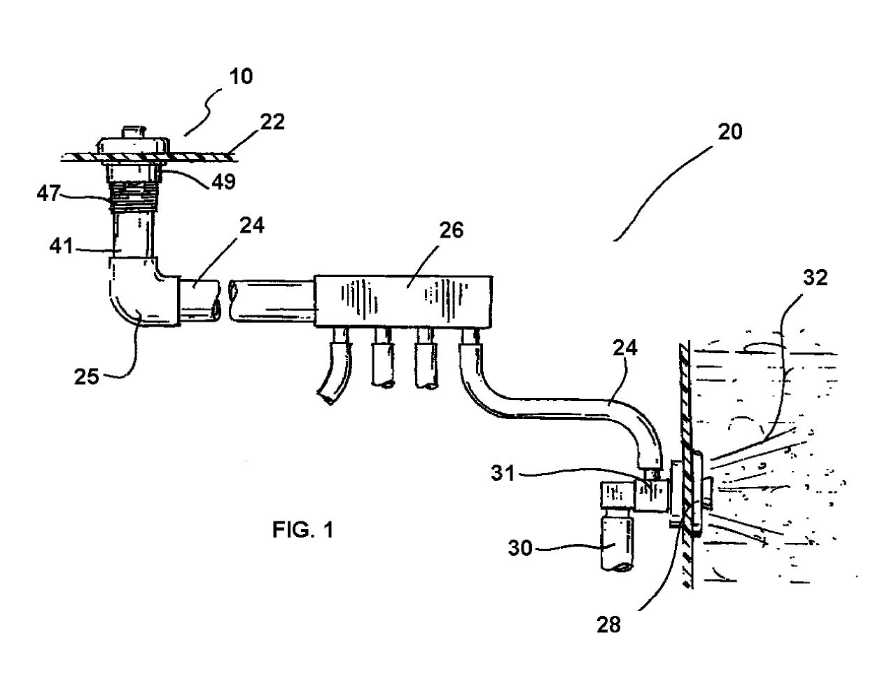

FIG. 1 illustrates the air control valve 10 installed in an exemplary piece of hydrotherapy equipment, e.g., a spa 20. Generally, the air control valve 10 may be mounted on the shell 22 of the hydrotherapy equipment. An air flow conduit 24 is in fluid communication with the air control valve 10, a manifold 26, and at least one venturi jet 28. The mixing manifold 31 of venturi jet 28 receives water from inlet 30, combines the water with air received from the air flow conduit 24 to create the hydrotherapeutic sensation of water mixed with air blown from the venturi jet 28 into the spa water 32. Hydrotherapy equipment and systems such as those described herein may comprise at least one venturi jet 28 and at least one air flow conduit 24. The air flow conduit 24 is in fluid communication with the atmosphere, the air control valve 10 and the at least one venturi jet 28. The air control valve 10 and the venturi jet(s) 28 are in fluid communication with the at least one air flow conduit 24. The amount of air flowing through the venturi jet 28 in combination with the water flowing therethrough may be increased, decreased or otherwise regulated by manipulation of the air control valve 10.

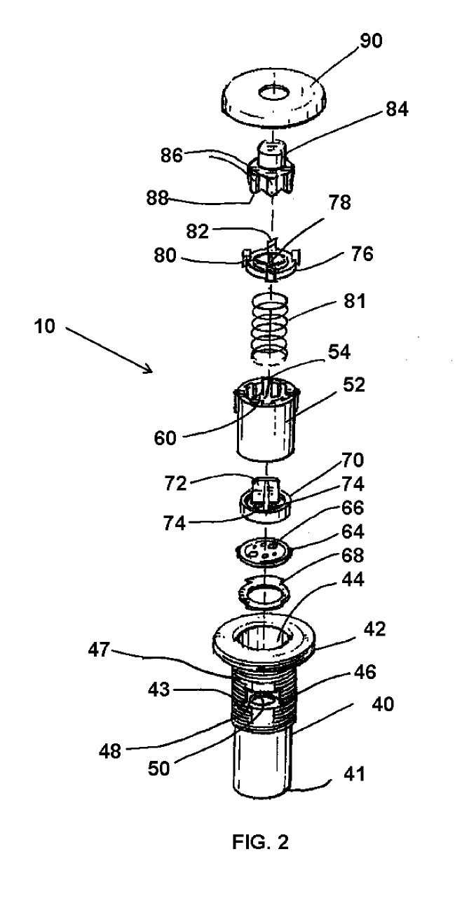

Turning now to FIG. 2, an exploded view of a preferred embodiment of the air control valve 10 is provided. The air valve housing 40 is illustrated with a flange 42 for mounting to the hydrotherapy equipment shell 22 as shown in FIG. 1. The housing 40 further includes a side wall 43, illustrated as cylindrical but other equivalent shapes will readily present themselves to those skilled in the art and are within the scope of the present invention. The side wall 43 of the housing 40 defines an interior chamber 44. An air flow entry port 46 is provided through the side wall 43, allowing fluid communication between the atmosphere and the at least one air flow conduit 24 discussed in connection with FIG. 1. The interior chamber 44 further comprises a base 48 with an aperture 50 therethrough.

The base 41 of the valve 10 is structured to permit attachment of a pipe or similar structure to facilitate an air flow conduit 24 from aperture 50 to venturi jet 28 through air flow conduit 24 and manifold 26. For example, air flow conduit 24 can comprise a connector 25 that fits over the base 41. For another example, air flow conduit 24 can have an outer diameter approximately equal to the inner diameter of base 41 such that air flow conduit 24 can slide within base 41 and be held there by friction. Housing 40 further includes a threaded portion 47 for cooperating with a nut 49 for attaching the device 10 to the spa equipment shell 22.

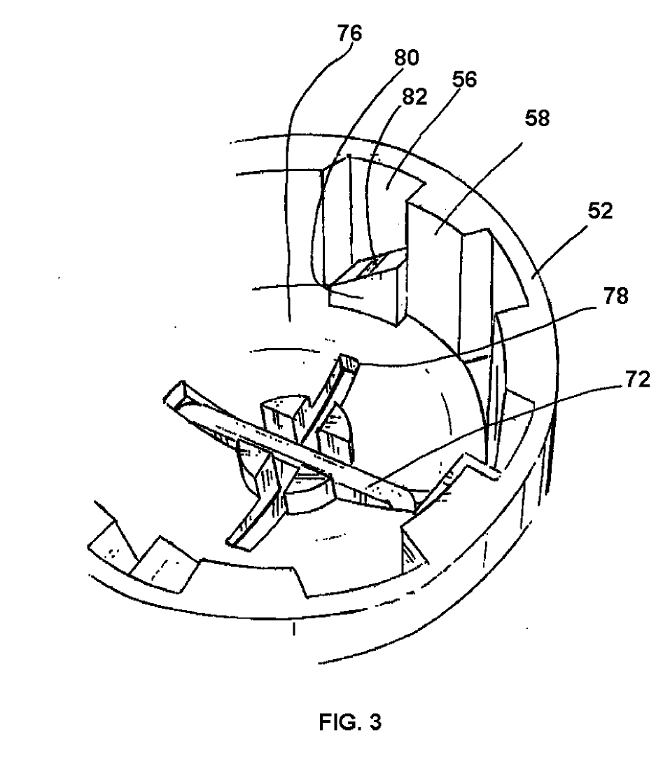

With reference now to FIGS. 2 and 3, a slotted cylinder 52 is fixed and attached within the interior chamber 44. The slotted cylinder comprises an interior side wall 54, and a plurality of slots 56 and ridges 58 extending axially partway down the side wall 54. The lower surfaces 60 of each ridge 58 are cammed. The lower surface of the interior chamber 44 comprises in one embodiment, a plate 64 with air flow ports 66 therethrough, with a seal gasket 68 interposed between the base 48 and the plate 64. Those skilled in the art will recognize that the lower surface 62 may be equivalently constructed using air flow ports 64 fixed in the base 48 instead of using a plate 64 with gasket 68.

A rotating member 70 operationally engages the lower surface, in the embodiment shown, the plate 64 is engaged by the rotating member 70. The rotating member comprises a male engagement member 72 and a plurality of air flow apertures 74. A disc 76 having engagement slots 78 corresponding to the male engagement members 72 of the rotating member 70 is provided. This engagement relationship is best illustrated in FIG. 3. The disc further includes a plurality of ridge members 80 having cammed upper surfaces 82 corresponding to the cammed lower surfaces 60 of the ridges 58 in the slotted cylinder 52. A spring 81 is operationally interposed between the rotating member 70 and the disc 76, providing an upward axial force when the air control valve 10 is assembled.

A push button controller 84 is provided with a plurality of ridges 86, the ridges having cammed lower surfaces 88 corresponding to the cammed upper surfaces 82 corresponding of the disc ridge members 80. The ridges 86 of the push button controller 84 correspond and operationally engage the slots 56 of the slotted cylinder 52.

A retention cap 90 is provided to compress the spring 81 and retain the elements in operational configuration. The cap 90 may be attached to the valve assembly by threaded attachment to the housing flange 42.

Assembly of the valve components into operational configuration results in the lower cammed surfaces 88 of the push button controller 84 to engage the corresponding ridge member upper cammed surfaces 82 of the disk 76. In turn, as is best seen in FIG. 3, the ridge members 80 of the disk 76 slidably and operably engage the slots 56 of the slotted cylinder 52, compressing the spring 81 and causing the spring 81 to exert a force axially upward. The engagement slots 78 of disk 76 receive the male engagement member 72 of rotating member 70, enabling co-rotation of the disk 76 and the rotating member 70 when air control valve 10 is actuated.

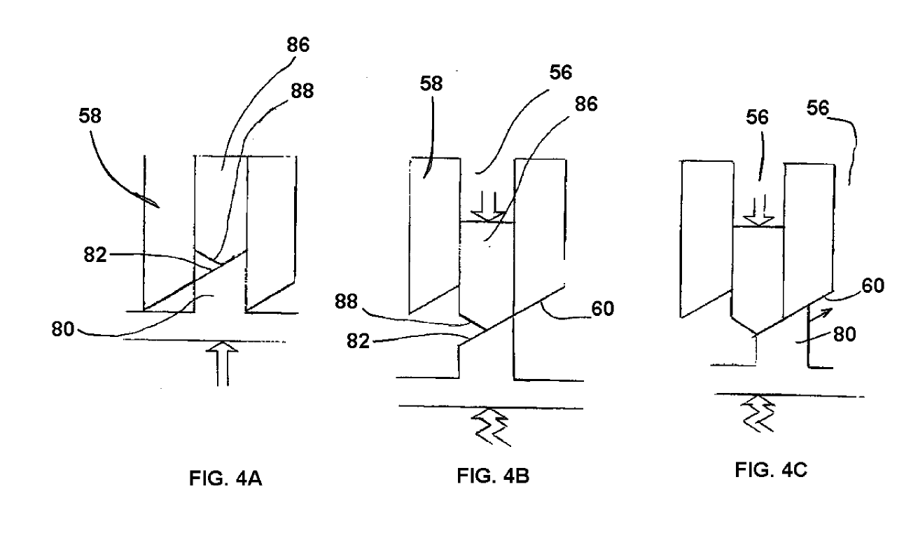

Actuation of the cammed assembly will now be described with reference to FIGS. 3 and 4A, 4B and 4C. Generally, the cammed assembly comprises at least one axial member, in various embodiments, the push button controller 84, the slotted cylinder 52, and the disc 76 and at least one rotational member, in various embodiments the rotating member 70, all working in operative communication. Actuation of the at least one axial member results in axial movement against the force of the spring 81 and translating such axial movement into rotational movement of the at least one rotational member 70. In this manner, the at least one rotational member 70 is urged into one of a plurality of rotational positions within the interior chamber 41. Each rotational position may change or regulate the volume of air flow through the air flow conduit 24 supplying air to the venturi jet 28.

One embodiment of the cammed assembly actuation is initiated by application of force to the push button controller 84 sufficient to overcome the upward axial spring force, illustrated in FIG. 4A as an upward uncompressed arrow. Subsequent compression of the spring 81 during actuation is illustrated in FIGS. 4A and 4B by a compressed arrow.

Applying sufficient force to overcome the spring force causes the push button controller ridges 86 to slide axially downward within the slotted cylinder slots 56. Concurrently, since the lower cammed surfaces 88 of the controller ridges 86 are engaged with the corresponding upper cammed surfaces 82 of the ridge members 80 of disc 76, the ridge members 80 also slide axially downward in cylinder slots 56. Ultimately, as the slotted cylinder slots 56 extend axially only partway down the interior side wall 54, the ridge members 80 of disc 76 disengage the slotted cylinder slots 56.

At this point, the upper cammed surfaces 82 of the ridge members 80 of disc 76 are urged by the upward axial spring force to engage the corresponding lower cammed surfaces 60 of the ridges of the slotted cylinder 52, immediately adjacent to the slots 56. The spring 81 continues to exert an upwardly axial force, which urges the cammed upper surfaces 82 of the ridge members 80 of disc 76 to slide upwardly and to rotate in direction of the upwardly angled arrow in FIG. 4C. This upward rotational motion continues until the ridge members 80 locate and engage the next adjacent set of slots 56, sliding axially upwardly into the slots 56 in response to the upward force of the spring 81.

Because the rotating member 70 and the disc 76 are operationally engaged, the rotating member 70 rotates at the same time and through the same rotational distance as the disc 76. In this embodiment, the distance rotated, and the corresponding rotational position achieved, is the distance from one slot 56 in the slotted cylinder 52 to the adjacent next slot 56 therein.

The present invention uses the rotation of the rotating member 70, in conjunction with the plurality of air flow apertures 74 in the rotating member 70 and the plurality of air flow ports 66 disposed through the interior chamber lower surface, to incrementally regulate the air flow through the at least one air flow conduit 24 to the venturi jet(s) 28. Each rotational position achieved by actuation of the cammed assembly and rotation of the rotating member 70 may regulate the air flow to the venturi jet 28 by either fully opening the valve 10 to air flow, fully stopping air from flowing through the valve 10 or incrementally restricting, without fully stopping, the air flow through the valve 10.

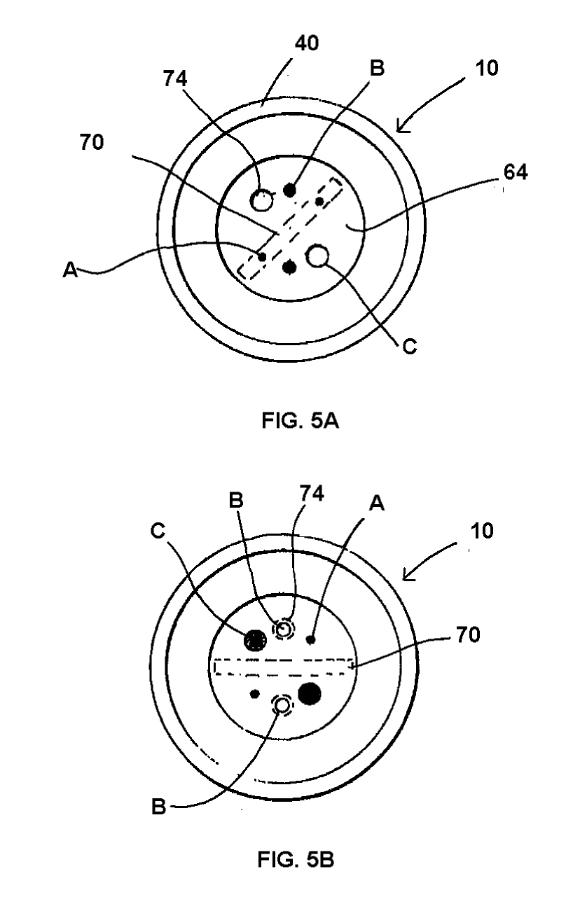

FIGS. 5A and 5B provide a bottom view of one embodiment of the air control valve 10 of the present invention with the rotating disc 70 shown in phantom. As illustrated by FIG. 5A, the lower surface of the interior chamber 44, represented in this embodiment by plate 64 as discussed above, has three sets of air flow ports of varying size; a small air flow port set A, a medium air flow port set B and a large air flow port set C. The rotating member 70 is shown having one set of air flow apertures 74, matching generally the size of the large air flow port set C.

FIG. 5A illustrates the case where the rotational position of the rotating member 70 aligns the air flow apertures 74 with the large air flow port set C of the lower surface of the interior chamber 44. This provides the maximum volume of air flow possible through the valve 10 and, consequently through the air flow conduit 24 and the venturi jet 28. The remaining air flow port sets A, B are illustrated as shaded, indicating that they are not aligned with any air flow apertures 74 on the rotating member 70, consequently no air is allowed through A or B.

FIG. 5B illustrates a second possible rotational position wherein the medium air flow port set B of the lower surface of the interior chamber 44 is aligned with the air flow apertures 74 of the rotating member 70. In this instance, since the diameter of the aligned holes B, 74 is smaller than that shown in FIG. 5A, the volume of air flow through the air flow conduit will be reduced compared with the rotational position of FIG. 5A. As in FIG. 5A, the remaining air flow air flow ports A, C are not aligned with the air flow apertures 74 and, therefore, do not allow air to pass through.

Those skilled in the art will recognize many equivalent configurations of air flow apertures and air flow ports, including orientation relative to each other, size, shape and the like in order to incrementally regulate the volume of air flow through the air flow conduit. Each of these configurations is within the scope of the present invention.

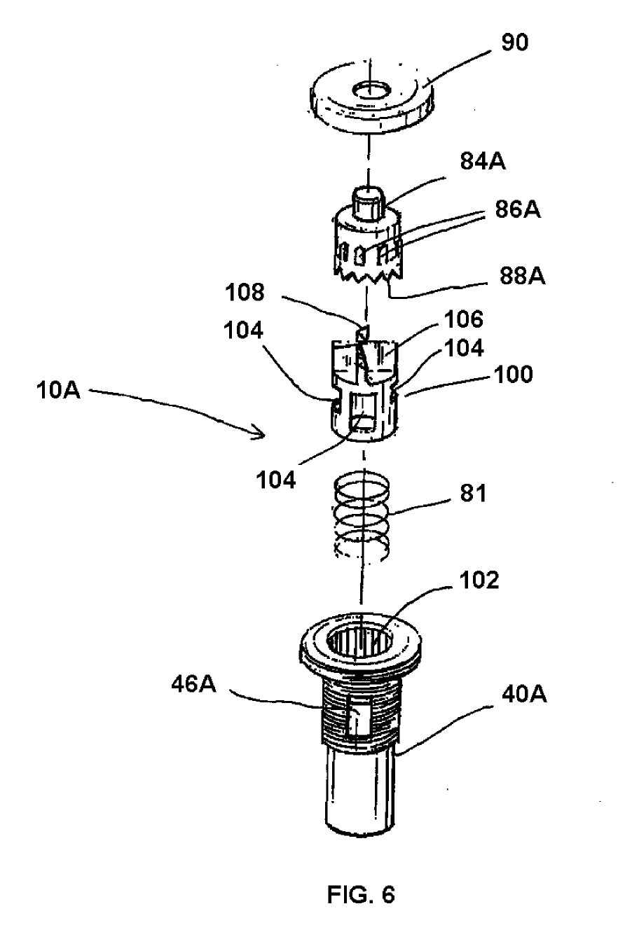

Turning now to FIG. 6, an alternate embodiment of the air control valve is presented. This embodiment is similar to the preferred embodiment discussed above in that axial movement is translated into rotational movement to regulate air flow through the valve 10A. However, in this embodiment, a rotating cylinder 100 is placed within a slotted cylinder 102. As before, the valve housing 40A is provided with an air entry port 46A. A spring 81 is placed within the interior of the housing 40A and engaged operationally by the rotating cylinder 100. The push button controller 84A engages the rotating cylinder 100 and the retention cap 90 is, in this embodiment, threaded onto the valve housing 40A as before.

The rotating cylinder 100 rests within the slotted cylinder 102 and has a plurality of different sized ports 104 to allow intake of different volumes of air. Rotating cylinder 100 further includes a plurality of engagement arms 106 having an upper cammed surface 108.

The push button controller 84A includes ridges 86A that correspond to at least some of the slots in slotted cylinder 102. Cammed surfaces 86A correspond to cammed surfaces 108 in the rotating cylinder.

Operationally, spring 81 exerts an upward axial force that may be overcome by actuating the cammed assembly. Pressing the push button controller 84A causes ridges 86A to slide downward and axially within slots 102. Cammed surfaces 88A and 108 are engaged during the downward axial movement and urge the rotating cylinder 100 to rotate accordingly. In this manner, air flow ports 104 are consecutively rotated into alignment, or partial alignment, with air flow entry port 46A. Regulation of the volume of air flow through the valve 10A is thus achieved in incremental fashion by regulating the size, and alignment, of the air flow ports 104 with the air flow entry port 46A.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. An air flow control valve for hydrotherapy equipment, wherein the hydrotherapy equipment includes at least one venturi jet, the valve comprising:
a valve housing having an interior chamber, and at least one air flow entry port therethrough;
a cammed assembly operationally disposed at least partly within the interior chamber, comprising at least one axial member in operative communication with at least one rotating member, wherein actuation of the cammed assembly translates axial movement of the at least one axial member into rotational movement of the at least one rotating member whereby the at least one rotating member is urged into one of a plurality of rotational positions within the interior chamber;
at least one air flow conduit, wherein the at least one conduit is in fluid communication with the at least one air flow entry port, the interior chamber and at least one venturi jet, and wherein the at least one conduit directs a volume of air flowing through the conduit from the at least one air flow entry port to the at least one venturi jet during operation and wherein the volume of air flow through the conduit to the at least one venturi jet is incrementally regulated by the rotational position of the at least one rotating member of the cammed assembly.

2. The air flow control valve of claim 1, wherein the cammed assembly further comprises a push button controller in operative communication with the at least one axial member.

3. The air flow control valve of claim 2, wherein the push button controller further comprises a plurality of ridges, the ridges having cammed lower surfaces thereon.

4. The air flow control valve of claim 3, wherein the cammed assembly further comprises a slotted cylinder fixed within the interior chamber, the cylinder having an interior side wall and a plurality of slots and ridges extending axially partway down the side wall, the ridges having cammed lower surfaces, and wherein the push button controller ridges are slidably engaged with the slots of the slotted cylinder.

5. The air flow control valve of claim 4, wherein the cammed assembly further comprises a disc having a plurality of ridge members with cammed upper surfaces, the ridge members slidably engaged with at least some of the plurality of slots of the slotted cylinder.

6. The air flow control valve of claim 5, wherein the cammed lower surfaces of the push button controller operatively engage the disc ridge member cammed upper surfaces.

7. The air flow control valve of claim 6, wherein the interior chamber comprises a lower surface, the lower surface having a plurality of air flow ports therethrough.

8. The air flow control valve of claim 7, wherein the at least one rotating member of the cammed assembly further comprises a plurality of air flow apertures, the rotating member operationally positioned on the interior chamber lower surface.

9. The air flow control valve of claim 8, wherein the cammed assembly further comprises the disc and the rotating member in operational engagement and a spring operationally interposed between the disc and the rotating member.

10. The air flow control valve of claim 9, wherein actuation of the cammed assembly urges the disc axially against the spring and the disc ridge members axially out of the slotted cylinder slots.

11. The air flow control valve of claim 10, wherein the axial force from the spring urges the upper cammed surfaces of the disc ridge members against the corresponding lower cammed surfaces of the slotted cylinder, wherein the disc rotates until the ridge members locate and slide into the next slotted cylinder slot and wherein the rotational member concomitantly rotates to the corresponding rotational position.

12. The air flow control valve of claim 8, wherein at least one of the rotational positions of the rotating member allows at least one of the interior chamber air flow ports to at least partially align with at least one of the rotating member air flow apertures, wherein air flows through the at least one air flow conduit to the venturi jet.

13. The air flow control valve of claim 12, wherein at least one of the rotational positions of the rotational member allows none of the interior chamber air flow ports to align with any of the rotating member air flow apertures, wherein air cannot flow to the venturi jet.

14. The air flow control valve of claim 13, wherein the interior chamber air flow ports are of varying size.

15. The air flow control valve of claim 13, wherein the rotating member air flow apertures are of varying size.

16. The air flow control valve of claim 15, wherein the interior chamber air flow ports are of varying size.

17. An air flow control valve for hydrotherapy equipment, wherein the hydrotherapy equipment comprises at least one venturi jet, comprising:
a valve housing having an interior chamber, and at least one air flow entry port therethrough;
a cammed assembly operationally disposed at least partly within the interior chamber, comprising at least one axial member in operative communication with at least one rotating member, wherein actuation of the cammed assembly translates axial movement of the at least one axial member into rotational movement of the at least one rotating member whereby the at least one rotating member is urged into one of a plurality of rotational positions within the interior chamber;
at least one air flow conduit, wherein the at least one conduit is in fluid communication with the at least one air flow entry port, the interior chamber and at least one venturi jet, and wherein the at least one conduit directs a volume of air flowing through the conduit from the at least one air flow entry port to the at least one venturi jet during operation and wherein the volume of air flow through the conduit to the at least one venturi jet is incrementally regulated by the rotational position of the at least one rotating member of the cammed assembly,
wherein the interior chamber comprises a lower surface, the lower surface having a plurality of air flow ports therethrough of fixed size, and the at least one rotating member of the cammed assembly further comprises a plurality of air flow apertures of varying size, the rotating member operationally positioned on the interior chamber lower surface, wherein at least one of the rotational positions of the rotating member allows at least one of the interior chamber air flow ports to at least partially align with at least one of the rotating member air flow apertures.

18. The air flow control valve of claim 17 wherein at least one of the rotational positions of the rotational member allows none of the interior chamber air flow ports to align with any of the rotating member air flow apertures, thereby blocking air flow to the venturi jet.

19. An air flow control valve for hydrotherapy equipment, wherein the hydrotherapy equipment comprises at least one venturi jet, comprising:
a valve housing having an interior chamber, and at least one air flow entry port therethrough;
a cammed assembly operationally disposed at least partly within the interior chamber, comprising at least one axial member in operative communication with at least one rotating member, wherein actuation of the cammed assembly translates axial movement of the at least one axial member into rotational movement of the at least one rotating member whereby the at least one rotating member is urged into one of a plurality of rotational positions within the interior chamber, the rotating member further comprising a rotating cylinder;
at least one air flow conduit, wherein the at least one conduit is in fluid communication with the at least one air flow entry port, the interior chamber and at least one venturi jet, and wherein the at least one conduit directs a volume of air flowing through the conduit from the at least one air flow entry port to the at least one venturi jet during operation and wherein the volume of air flow through the conduit to the at least one venturi jet is incrementally regulated by the rotational position of the at least one rotating member of the cammed assembly.

20. The air flow control valve of claim 19, wherein the rotating member further comprises a rotating cylinder having varying sizes of air ports alignable with the at least one air flow entry port of the valve housing.
